(19) United States
(12) Patent Application Publication
(10) Pub. No.: US 2004/0091262 A1
(43) Pub. Date: May 13, 2004

(54) Method and optical coder for coding a signal in an optical fibre network

(76) Inventors: Olli-Pekka Pohjola, Helsinki (FI); Markku Oksanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/466,075

(22) PCT Filed: Jan. 13, 2001
(86) PCT No.: PCT/EP01/00380

(51) Int. Cl. H04B 10/24

(52) U.S. Cl. 398/42

(57) ABSTRACT

The invention relates to an optical coder and a method for coding a signal in an optical fibre network, which signal is divided into bit periods, each bit period containing one or no short light pulse. In order to achieve reduced multiple access interference and at the same time an increased security, the each short light pulse is spread in time according to a predetermined code into a predetermined number of chips distributed over several bit periods and afterward, the chips are combined in a single signal again. The proposed optical coder comprises means (20-25) for such temporal spreading and means (21′-23′) for combining the spread chips again.

### FIELD OF THE INVENTION

The invention relates to a method and an optical coder for coding a signal in an optical fibre network, which signal is divided into bit periods, each bit period containing one or no short light pulse.

### BACKGROUND OF THE INVENTION

Optical fibres allow a transmission of signals with a huge bandwidth. In order to be able to share this bandwidth for several connections without the need for complicated electronic signal processing, optical code-division multiple access (OCDMA) to the optical fibres was introduced. The most common OCDMA systems are coherent or incoherent, synchronous or asynchronous, based on temporal or spectral coding or on frequency-hopping, which constitutes a combination of temporal and spectral coding. The present invention relates to temporal and frequency-hopping coding systems.

In optical fibre networks, a regular sequence of short light pulses can be used as binary signal that is to be transmitted. Each light pulse represents one bit of the signal. A light pulse can be on, representing a “1”, or off, representing a “0” of the binary signal. The distance in time from one light pulse to the next is one bit period.

It is known in the state of the art to encode each light pulse for transmission by spreading it into chips distributed within one bit period. At the receiving end, a matching decoder de-spreads the chips but further spreads the pulses from other encoders, the further spread pulses being spread at the most over two bit periods. These further spread pulses build up a multiple access interference MAI in the receiving end. Since the total MAI in one bit period originates from only a few pulses, i.e. one or two pulses from each users, the MAI may change greatly from one bit period to another. More specifically, all chips in one bit period can be “1”s and all chips in the next bit period “0”s.

The amount of MAI per bit period varies from period to period depending on how many users are sending. “1”s at that moment. Therefore, in known OCDMA systems, signal detection is limited by multiple access interference at the sampling instant. Since the variation can be many times larger than the signal intensity, the setting of the threshold level in the receiver is complicated.

Moreover, in broadcast and select networks, the known methods and encoders lead to a security problem, if selection is made in the users premise, since in this case all data goes to every user. The user is only allowed to see the part of the data that was directed to him. However, it is not prevented efficiently that a user retrieves data that was directed at some other user, since the code inside one bit period can be solved quite easily with the right equipment.

### SUMMARY OF THE INVENTION

It is an object of the invention to provide a method and an optical coder for coding short light pulses resulting in reduced multiple access interference variations, and which method and coder ensure at the same time an increased security.

On the one hand, this object is reached by a method for coding a signal in an optical fibre network, which signal is divided into bit periods, each bit period containing one or no short light pulse, the method comprising the step of time spreading each short light pulse according to a predetermined code into a predetermined number of chips distributed over several bit periods and the step of combining the chips in a single signal.

On the other hand, the object is reached by an optical coder for coding a signal for transmission in an optical fibre network, which signal is divided into bit periods, each bit period containing one or no short light pulse, the coder comprising means for time spreading each short light pulse according to a predetermined code into a predetermined number of chips distributed over several bit periods and means for combining the chips in a single signal.

With the method and the coder of the invention, the fluctuation of the MAI from one bit period to the next is reduced, since the MAI now originate from several pulses instead of from one user, which all can be “0” or “1”.

Moreover, the achieved security is increased, since the code for the distribution of the chips over several bit periods has to be solved in order to obtain the code for de-spreading the chips correctly. This is more difficult than solving only a code of the distribution of chips inside a single bit period.

The term coding or coder is to be understood to include equally encoding or encoder and decoding or decoder, since the difference consists only in the code that is applied to the respective pulses. E.g., if delay lines are used for coding, in a decoder with delay lines that are a time-reversed version of the delay lines used in an encoder, the original light pulse send to the encoder is recovered. Only if the codes mismatch, the chips are spread along the bit period.

Preferred embodiments of the invention become apparent from the subclaims.

With the method and the coder of the invention, the light pulses can be spread only in time or in time and over several frequencies.

Preferably, the light pulses are spread at least over as many bit periods as chips that are created, more preferably over double the number of chips created.

In a corresponding coder according to the invention, the short light pulses are advantageously spread by one delay line per chip originating from one pulse. Each delay line can place one of the formed chips into a dedicated bit period. In case the light pulse is additionally to be spread in frequency, each delay line is dedicated to a specific frequency and only the frequency bin chip with this frequency is provided to the respective delay line.

In a further preferred embodiment, each chip is delayed in time over an integer multiple of the bit period plus a fraction of the bit period. For each chip of one light pulse a different integer multiple and a different fraction is used.

This can be achieved most simply by first spreading the light pulses according to a first predetermined code into chips distributed within one bit period. Afterwards, each created chip is delayed according to a second predetermined code over several bit periods. Naturally, the order of applying the two codes can be changed. A corresponding coder advantageously comprises delay lines that are made up of two parts, where each part can also be formed by a separate delay line. A first part is used for delaying each chip within one bit period and a second part is used for delaying the respective chip over an integral number of bit periods. With such a double spreading, the achieved security is particularly good, since two codes, the code for the distribution inside a bit period, and the code for the distribution over the several bit periods has to be solved in order to obtain the complete code for de-spreading the chips correctly.

In order to distribute a short light pulse to several delay lines in an coder of the invention, splitters can be employed if the light pulse is to be spread only in time. In this case, coupler are used after the spreading to combine the chips leaving the different delay lines to a single signal again. If the short light pulse is a broadband light pulse and to be spread in time and in frequency, wavelength selective components can be employed for spreading the light pulse into frequency bin chips and for feeding each frequency bin chip to one of the delay lines. Such wavelength selective components can be e.g. interleavers, Fibre Bragg gratings (FBG), Arrayed Waveguide Grating (AWG), or wavelength division multiplexing (WDM) filters. For combining the delayed frequency bin chips again, either wavelength selective components or couplers can be employed.

In one alternative, the splitters are arranged on the one end of the delay lines and the couplers on the other end. If wavelength selective components are employed for coding by frequency hopping, they are equally arranged on both ends of the delay lines, or wavelength selective components on one end and couplers on the other.

In a second alternative, one end of the delay lines is connected to splitters or wavelength selective components respectively, the other end of the delay lines being terminated by reflecting means for reflecting the created chips and for sending them back through the delay lines to the splitters or the wavelength selective components. The total delay of each chip is therefore twice the delay of one way through the delay lines. Accordingly, the delay lines have to have a length half of the length of delay lines that are to be passed only once for achieving the same coding. In this case, the splitters and the wavelength selective components respectively are employed for both, splitting the incoming light pulse into chips and combining delayed chips to a single signal. When using reflecting means, further means should be provided for separating incoming light pulses from output coded signals. The advantage of such an arrangement with reflectors is that the number of the expensive optical components that have to be employed is reduced.

In another preferred embodiment, the coding of the light pulses is achieved by fibre Bragg gratings. For the use of FBG, an optical fibre is provided with gratings along the fibre, each grating being designed to reflect of an incoming light pulse a specified fraction of a specified wavelength at a specified distance in the fibre. Accordingly, an input light pulse can be spread only in time by providing several gratings with the same reflection band, the spread signal being output as combined single signal at the input. Alternatively, an input broadband light pulse can be split up into several wavelengths, a chip with each wavelength of the input light pulse for which a grating is present being received again at the input with another time delay. The time delays are determined in both cases by the distance to the respective grating and back. The physical length of each grating determines the wavelength reflected, the reflectivity and the shape of the grating spectrum.

If the method according to the invention is used for frequency-hopping coding based on fibre Bragg gratings (FBG), another problem of the state of the art is solved at the same time. In the known coding methods, the light pulses are spread in time over one bit period. In FBG, the distance between the gratings depends on the bit rate and the weight of the code, i.e. the number of gratings. The maximum distance between the first and the last grating is less than half of the bit period, since the way to the last grating and back has to be covered in less than one bit period. When the bit rate has to be increased, the bit period and therefore the length of the fibre available for distributing the gratings is decreased. Equally, when the weight of the code is to be increased by increasing the number of gratings within half a bit period, the gratings approach each other. For high-weighted coding and/or high bit rates, the gratings have to be short and close to each other. When the gratings meet, the combination of bit rate and the weight of the code has reached its limit.

When multiple bit period coding is used with FBG, the gratings are distributed over half of the length of the fibre that can be traversed by light pulses during the multiple bit periods. Accordingly, the gratings can be spaced more apart and be longer. Additionally or alternatively, a higher bit rate and/or a higher weighted coding can be chosen. With FBG coding, used in a method or an coder according to the invention, especially very narrow passband gratings are easier to design.

The proposed coders can be modified for a use as bi-directional coders for asymmetric traffic. Coders are rather expensive parts of frequency-hopping OCDMA systems. To make systems more cost effective number of coders should therefore be minimised, e.g. by using them bi-directionally. The coders described until now, just like coders known from the state of the art, could partly be used bi-directionally, but not for asymmetric coding of asymmetric traffic. Traffic in access networks, though, is typically asymmetric.

In a bi-directional coder for asymmetric traffic according to the invention, the means for time spreading short light pulses are designed to spread short light pulses with a first, higher bit rate into a predetermined number of chips distributed over several bit periods of the higher bit rate. This corresponds to the spreading of the until now described coders according to the invention. In addition those means are designed to spread at the same time short light pulses with a second, lower bit rate into the predetermined number of chips distributed within one bit period of the lower bit rate.

The components are identical as in the other coders, only the means for time spreading the chips are designed in a way that asymmetric bi-directional traffic in one fibre can be supported. The codes and the bit rates are not entirely independent in the two different directions, but numerous combinations are possible.

The coding of the short light pulses with the higher bit rate constitutes preferably a coherent coding.

A preferred embodiment of a method according to the invention comprises the corresponding steps for asymmetric bi-directional coding.

Bi-directional use of coders halves the number of coders compared to a unidirectional use. Moreover fewer fibres have to be employed as long as the available fibre capacity is not exhausted. The installing of new fibre cables to the ground is usually very expensive. Therefore, it is an aim to use as few fibres as possible in optical systems. This is of particular interest, when an operator does not have a fibre structure of his own but leases fibres from other operators. Along with the number of coders and fibres, the number of fibre connections can be reduced, which makes the system easier to install, since only one fibre is going to each location and it is not possible to misconnect the directions.

All advantages achieved with the different embodiments of the first described coders are given for the first, higher speed direction of the asymmetric traffic with the proposed bi-directional coder as well, since the preferred embodiments can be applied equally to the bi-directional coder for asymmetric traffic.

In particular, a corresponding reflection of chips of both bit rates can be employed for saving separate means for combining the delayed chips. In case a circulator is employed for separating incoming pulses from output combined chips, further means have to be provided for feeding the light pulses with the different bit rates in parallel to the circulator and for distributing the signals output by the circulator to the different directions again.

To avoid reflections and Rayleigh scattering in a single fibre used in both directions, the proposed bi-directional coders should use different frequencies for the different directions.

An optical coder that is to be used for decoding a signal encoded with one of the optical coder of the invention can comprise the same means as the coder used for encoding. The means for temporal spreading only have to be suited for a time reversed delay of supplied chips.

The coders and the methods of the invention are particularly suited to be employed in an IP (Internet Protocol) network, an ATM (Asynchronous Transfer Mode) network, including an IP/ATM network, or a Ethernet network.

The coders and the methods according to the invention can be combined with coders and coding methods as well as be used in network architectures proposed in applications of the same filing date by the same applicant, titled “OCDMA network architectures, optical coders and methods for optical coding” and “Method for optical coding, optical coder, and OCDMA network architecture”, both incorporated by reference herewith. For example, coherent multi-bit period frequency-hopping can be used in higher speed directions and incoherent frequency-hopping in lower speed direction, e.g. by adding extra reflectors behind the coherent coders. Different directions must then use different frequencies. If multi-bit period coding is used in a cascaded temporal and frequency-hopping coding and both coders are used bi-directionally, both should be asymmetric.

### BRIEF DESCRIPTION OF THE FIGURES

In the following, the invention is explained in more detail with reference to drawings, of which

FIG. 1a illustrates a method for OCDMA coding known from the state of the art;

FIG. 1b illustrates a method for OCDMA coding according to the invention;

FIG. 2 schematically shows a first embodiment of an encoder according to the invention;

FIG. 3 schematically shows a second embodiment of an encoder according to the invention;

FIG. 4a illustrates the structure of a known encoder based on FBG;

FIG. 4b illustrates the structure of a third embodiment of an encoder according to the invention based on FBG;

FIG. 5 schematically shows a forth embodiment of an encoder according to the invention; and

FIG. 6 schematically shows a sixth embodiment of an encoder according to the invention.

### DETAILED DESCRIPTION OF THE INVENTION

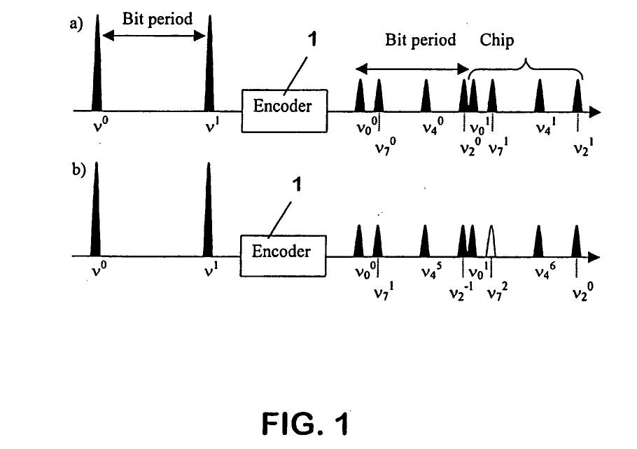

FIGS. 1a and 1b oppose a method for coding a signal for transmission in an optical fibre network known from the state of the art to the method according to the invention.

Both figures show on the left hand side original short broadband light pulses v⁰ and v¹, in the middle an encoder 1 and on the right hand side a sequence of chips encoded for transmission. The distance between the short light pulses v⁰ and v¹ is one bit period, each light pulse representing the value of one bit of a signal. The encoder 1 is in both cases some frequency-hopping encoder according to the invention.

FIG. 1a illustrates the coding known from the state of the art. Each light pulse v⁰, v¹ is spread in time within one bit period into chips with different frequencies 0, 2, 4, 7. The chips resulting from the first light pulse v⁰ are distributed according to some frequency-hopping code in a first shown bit period as chips v₀⁰, v₇⁰, v₄⁰ and v₂⁰. The chips resulting from the second light pulse v¹ are distributed according to the same code in a second shown bit period as chips v₀¹, v₇¹, v₄¹ and v₂¹. The low indices indicate the frequency of each chip, the high indices the pulse from which the chip originates.

In contrast, FIG. 1b demonstrates the coding according to the invention. Each light pulse is spread by the encoder 1 over a plurality of bit periods, each chip originating from the same light pulse having just as in FIG. 1a a different frequency 0, 2, 4, 7 and a different position within the respective bit period. In the two bit periods shown, chips resulting from the first light pulse v⁰ are chip v₀⁰ in the first bit period and chip v₂⁰ in the second bit period. Chips resulting from the second light pulse v¹ appear as chips v₇¹ and v₀¹ in the first and in the second bit period respectively. In addition, chips v₂⁻¹, v₇², v₄⁵, v₄⁶ resulting from one preceding and from three following (not shown) light pulses v⁻¹, v², v⁵, v⁶ are distributed with different frequencies indicated by the low indices, over the two shown bit periods. Like in the example in FIG. 1a, a certain position in a bit period is always occupied by a chip with the same frequency, but here, the chips in one bit period result from different light pulses.

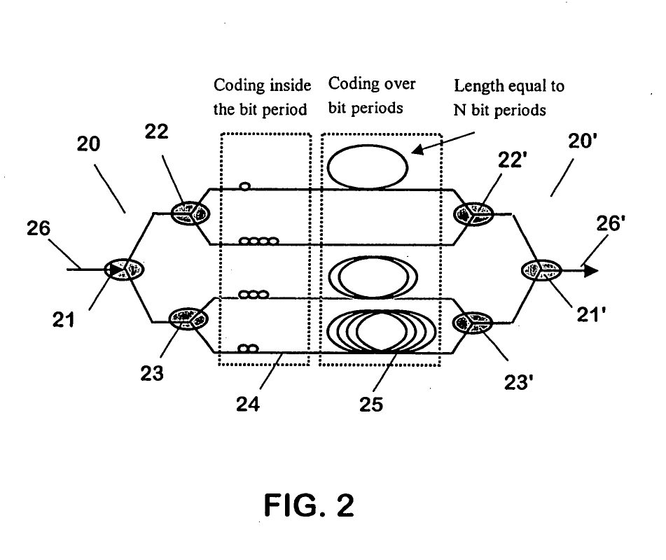

FIG. 2 schematically shows a first embodiment of an encoder according to the invention that can be used for the proposed encoding by frequency-hopping.

The encoder comprises a first and a second cascade 20, 20′ of wavelength selective components. Each cascade has one wavelength selective component 21, 21′ in a first stage connected on the one hand to a single fibre 26, 26′ and on the other hand via two connections to two further wavelength selective components 22, 23, 22′, 23′ forming a second stage of the cascade 20, 20′. Each of the further wavelength selective components 22, 23, 22′, 23′ has moreover two connections facing away from the cascade 20, 20′. Each of those connections of the first cascade 20 is connected via a separate series of a first and a second optical delay line 24, 25 to a corresponding connection of the second stage of the second cascade 20′. The different first delay lines 24 have different lengths corresponding to different delays within one bit period. The different length are symbolised by different numbers of small loops in each line 24. Each of the second delay lines 25 has a length corresponding to N bit periods, where N is a different integer number for each of the second delay lines 25. Here, the different length are symbolised by different numbers of large loops in each line 25. The wavelength selective components 21-23, 21′-23′ can be e.g. interleavers, AWG, FBG or WDM filters. A cascading of the components, however, is only needed with interleavers.

A short broadband light pulse entering the first cascade 20 via the fibre 26 is split by the first wavelength selective component 21 of the first cascade 20 into two frequency bin chips and each of these frequency bin chips is split again into two further frequency bin chips by one of the wavelength selective components 22,23 of the second stage of the cascade 20. Each of the resulting four frequency bin chips is output by a respective one of the outward facing connections of the components 22, 23 of the second stage and fed to the respectively connected delay line 24. Each frequency bin chip is delayed individually in the respective first delay line 24 within one bit period and subsequently in the respective second delay line 25 over several bit periods. Since each second delay line 25 is exactly equal to N bit periods, each chip is moved by the second delay line 25 to the same place within a bit period determined by the first delay line 24 in another bit period. The twice delayed frequency bin chips are combined to a single signal again by the second cascade 20′ in a manner reversed to the splitting by the first cascade 20, leading to a temporal chip sequence like the one depicted in FIG. 1b, which is output to fibre 26′. The original light pulse is therefore modified in the time and the frequency domain.

The second cascade 20′ can comprise couplers instead of wavelength selective components 21′-23′, if the coder is to be used in one direction only. Moreover, the encoder can be designed for pure temporal coding, in which case splitters are used instead of wavelength selective components 21-23 in the first cascade 20. Such splitters are able to split a light pulse into different chips of the same frequency. The processing by the delay lines 24, 25 and the combining of the delayed chips would be identical as described for frequency-hopping encoding.

A corresponding decoder comprises delay lines that are a time-reversed version of the delay lines used in the encoder. Therefore, the original pulse send to the encoder can be recovered. If the codes represented by the delay lines mismatch, the chips are spread along many bit periods so that all chips in one bit period originate from different pulses. Code mismatch in prior art solutions, in contrast, lead typically to w/2 chips from the same pulse in one bit period, where w is the weight of the code, i.e., the number of branches in the coder. Accordingly, each bit period contains maximally the chips resulting from two pulses, leading to a more fluctuating MAI.

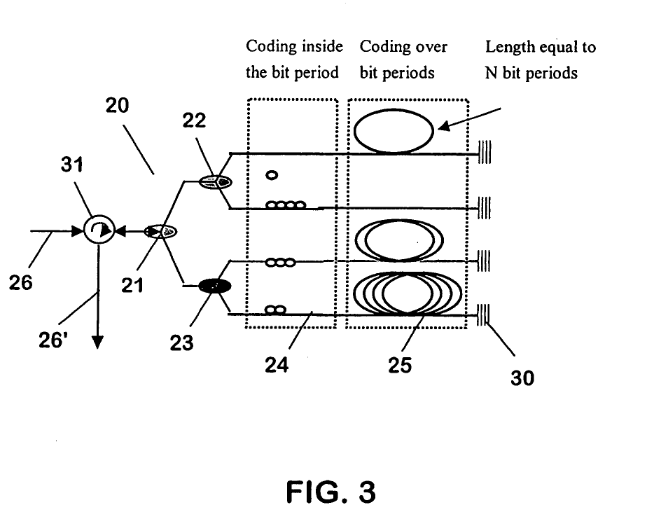

Another embodiment of an encoder according to the invention is depicted in FIG. 3. The embodiment is similar to the first embodiment of an encoder but requires only a single cascade 20, which is used bi-directionally.

The cascade 20 has the same structure as described with reference to FIG. 2. Equally, to the cascade 20 there is connected at each of the four connections of the second stage a series of two optical delay lines 24, 25, the first one 24 having a length corresponding to less than one half-bit period and the second one 25 having a length corresponding to N half-bit periods. At the other end of each of the respective second delay line 25, a reflector 30 is provided. In addition, the cascade 20 is connected at its first stage to an incoming fibre 26 and an outgoing fibre 26′ via a circulator 31, which constitutes a direction sensitive component.

A light pulse-arriving via the incoming fibre 26 is forwarded by the circulator 31 to the first stage of the cascade 20. Just like in the encoder of FIG. 2, the cascade 20 splits the received light pulse into four frequency bin chips. Each frequency bin chip is output to the series of delay lines 24, 25 assigned to the corresponding connection of the second stage of the cascade 20. The respective first delay line 24 delays the chip within half a bit period and the respective second delay line 25 delays the chip for N half-bit periods. The thus delayed chip is reflected by the respective reflector 30 and passes both respective delay lines 25, 24 for the same delaying in reversed order again. When arriving back at the cascade 20, each frequency bin chip has been delayed in the whole within one complete bit period and additionally over N complete bit periods. The resulting delay for each chip is therefore the same as in the encoder of the first embodiment.

The cascade 20 combines the delayed frequency bin chips again to a single signal. Since the resulting delay of each frequency bin chip is the same as in the encoder of FIG. 2, the output signal corresponds as well to the chip sequence depicted in FIG. 1b. The encoded signal is forwarded by the circulator 31 to the optical transmission fibre 26′.

The structure of the second embodiment of an encoder according to the invention minimises the number of required cascade components, because each component 21-23 of the cascade 20 is used twice.

Just like in the embodiment of FIG. 2, the encoder can also be designed for pure temporal encoding by employing splitters instead of wavelength selective components. Equally, the encoder of FIG. 3 can be employed as a decoder, if the lengths of the delay lines are selected in a way that they match the lengths of the delay lines of some encoder in a time-reversed manner. Also here, if the codes mismatch, the chips are spread along many bit periods.

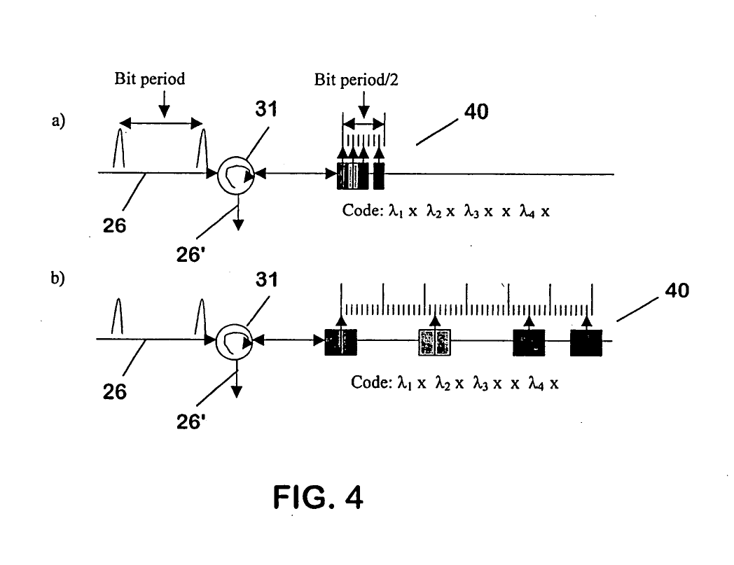

FIGS. 4a and 4b oppose as further example an FBG encoder known from the state of the art to a third embodiment of an encoder according to the invention based on FBG.

Both figures show on the left hand side a fibre 26 connected to an input of a circulator 31. Above the fibre 26, two of a sequence of broadband light pulses representing a signal that is to be transmitted via an optical fibre are shown. The circulator 31 has moreover an in- and output connected to fibre Bragg gratings 40 and an output connected to an optical fibre 26′. Four different boxes indicate four gratings with four different reflection bands. Instead of employing separate means for splitting and spreading a light pulse like in the embodiments of FIGS. 2 and 3, the fibre Bragg gratings 40 are used at the same time for splitting a light pulse into different frequencies bin chips and for encoding the frequencies bin chips in time. Similar to the embodiment of FIG. 3, no additional means are required for combining the delayed chips, only a direction sensitive component 31 for separating incoming and output signals.

FIG. 4a illustrates the FBG coding according to the state of the art. The gratings are distributed over a length of a fibre corresponding to half a pit period, therefore they are very close to each other. Since each of the four fibre Bragg gratings 40 has a different reflection band, each grating is designed for reflecting a different wavelength λ1-λ4 of an incoming signal.

A sequence of broadband light pulses arriving via fibre 26 is forwarded by the circulator 31 to the FBG. At the FBG, four different wavelengths λ1-λ4 of the light pulses are reflected at the four different positions of the gratings 40, leading to a spreading in time of the different selected frequency components of the original pulse within one bit period. The signal leaving the fibre with the FBG 40 again is forwarded by the circulator 31 to the optical fibre 26′ destined for transmission of the encoded signal. The signal is similar to the signal depicted in FIG. 1a.

FIG. 4b illustrates an FBG coding according to the third embodiment of the invention. The gratings 40 are distributed in a fibre over a length corresponding to six half-bit periods. Each of the fibre Bragg gratings 40 is designed for reflecting a different wavelength λ1-λ4 of an incoming signal and is located in another half-bit period. The position for each wavelength within that half-bit period, however, is the same as the position in the single half-bit period of FIG. 4a.

As in FIG. 4a, a sequence of broadband light pulses arriving via fibre 26 is forwarded by the circulator 31 to the fibre with the FBG 40. At the FBG 40, four different wavelengths λ1-λ4 of the light pulses are reflected again by four different gratings at four different positions, leading to a spreading in time of the different selected frequency components of the original pulse. But here, the spreading is carried out over several bit periods, because of the distribution of the FBG 40 over several half-bit periods. The combined signal leaving the fibre with the FBG 40 and forwarded by the circulator 31 is therefore similar to the signal depicted in FIG. 1b.

Because of the distribution of the FBG 40 over several half-bit periods, the gratings are more apart and can be longer. This makes especially very narrow passband gratings easier to design.

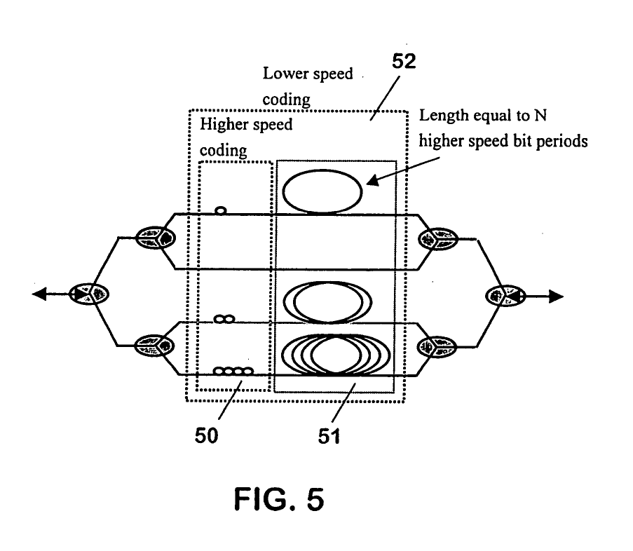

A fourth embodiment of an encoder according to the invention is now described with reference to FIG. 5. The encoder has the identical structure as the encoder of the embodiment of FIG. 2) to the description of which is referred, but resulting from a specific dimensioning of the delay lines it can be employed for bi-directional encoding of asymmetric traffic. In contrast to FIG. 2, each delay line 24, 25 of one of the series of delay lines is here referred to as part 50, 51 of a complete delay line 52.

Light pulses with a high bit rate are input to the coder at the first stage of the cascade 20 on the left side of the figure, which splits the high speed light pulses into four chips and feeds each chip to one of the delay lines 50/51, 52. Light pulses with a lower bit rate are input to the coder at the first stage of the cascade 20′ on the right side, which splits the low speed light pulses into four chips and feeds each chip to one of the delay lines 50/51, 52. The length of the light pulses is typically less than or equal to the length of the respective formed chips. More specifically, the length of the higher speed light pulses is less than or equal to the length of the higher speed chips and the length of the lower speed pulses is less than or equal to the length of the lower speed chips.

The encoder is used in the higher speed direction for multiple bit period temporal coding, as described with reference to FIG. 2. A first part 50 of each delay line is used for delaying the chips within one bit period of the high bit rate and a second part 51 for delaying a chip over several bit periods of the high bit rate. In the lower speed direction, in contrast, conventional coding by spreading the chips within only one bit period is employed. The complete delay line 52 for each chip has a length suitable for delaying the corresponding chip within a bit period of the lower bit rate.

In order to be able to employ the same delay lines 50/51, 52 in both directions, each delay line 50/51, 52 has to satisfy the equation:

tᵢ=Kᵢ·t_{chip,higher}+Nᵢ·t_{bit,higher}=Mᵢ·t_{chip,lower}.

In this equation, tᵢ is the total length of the i^{th} delay line 50/51, 52 with i=1 to 4. Moreover, t_{bit,higher} is the length of a delay line corresponding to a bit period of the higher bit rate and Nᵢ the number of bit periods of the higher bit rate over which the chips originating from light pulses with the higher bit rate are spread. Nᵢ·t_{bit,higher} is therefore the length of the respective part 51 of the delay lines. t_{chip,higher} is the length of a delay line corresponding to a chip length in higher speed directions and Kᵢ the number of chip lengths by which a chip in higher speed directions is to be delayed for spreading within one bit period. Kᵢ·t_{chip,higher} is therefore the length of the respective part 50 of the delay lines. Finally, t_{chip,lower} is the length of a delay line corresponding to a chip length in lower speed directions and Mᵢ the number of chip lengths by which a chip in lower speed direction is to be delayed for spreading within one bit period. Mᵢ·t_{chip,lower} is therefore the length of the delay line 52, which is composed of the parts 50 and 51. In OCDMA, codes Kᵢ and Mᵢ are typically integers in order to achieve a better cross-correlation between the codes.

Because receiving of the signal is easier in the lower speed direction, codes do not have to be so good in this direction and M can slightly differ from an integer. Bit rates and code combinations for the higher and lower speed directions are then easier to find. The pulse lengths can be equal to the chip lengths in both directions.

For decoding, the lengths of the corresponding delay lines in encoder t_{i,encoder} and decoder t_{i,decoder} are determined by

t_{i,encoder}+t_{i,decoder}=A

for all i, where A is some constant.

As in the embodiment of FIG. 2, the chips can be of a single frequency and be provided by splitters and combined by couplers, or they can be frequency bin chips, provided by wavelength selective components. If different frequencies are used in the different directions, the wavelength selective components should be able to process both directions. Interleavers are particularly suited as wavelength selective components for that purpose.

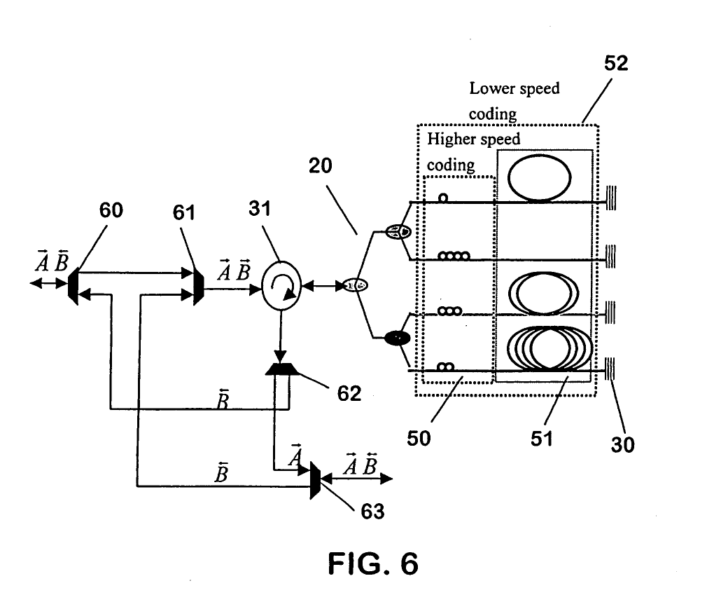

In case that a single cascade 20 is to be used in the described bi-directional coder by employing reflectors 30 like the coder of FIG. 3, some additional arrangements have to be provided, as shown in FIG. 6.

The coder itself, including a circulator 31 for separating incoming and output signals, is identical to the coder of FIG. 3, for which the lengths of the different parts 50, 51 of the delay lines 52 have been determined as described with reference to FIG. 5.

The circulator 31, which is connected to the first stage of the cascade 20, is connected in addition to means for supplying the light pulses with the different bit rates in parallel. Those means comprise four WDM components 60-63. WDM component 60 is connected on the one hand to a first light pulse source (not shown) and on the other hand via WDM component 61 and via WDM component 62 to the circulator 31. WDM component 63 is connected on the one hand to a second light pulse source (not shown) and on the other hand equally via WDM component 61 and via WDM component 62 to the circulator 31.

The first light pulse source provides high speed signals from a first direction, referred to as A, and the second light pulse source provides low speed signals from a second direction, referred to as B. The use of the WDM components 60-63 requires that the different directions A, B have different frequencies.

Incoming light pulses are first arranged in parallel by the WDM components 60-63 because the circulator 31 is not a bi-directional device. Signals A have to pass WDM component 60 before reaching the circulator 31 via WDM component 61 and signals B have to pass WDM components 63 before reaching the circulator 31 via the same WDM component 61. Signals from both directions A, B are fed by the circulator 31 to the first stage of the cascade 31.

The light pulses are separated into chips by the cascade 20, which are fed into the different delay lines 50/51, 52. The reflectors 30 reflect the chips back to the cascade 20, where they are combined again. After having passed the delay lines 50/51, 52 twice, the chips of the higher speed direction A are multi bit period temporal coded and the chips of the lower speed direction B are coded within one bit period. The lengths of the delay lines are determined as described with reference to FIG. 5, except that here each part 50, 51 of the delay lines and accordingly the total delay line 52 have only half the lengths compared to those of FIG. 5, since they are used for delaying twice. The direction selective circulator 31 separates the incoming signals from the signals output by the cascade. The WDM components 60, 62, 63 direct the output signals again to opposite directions. Low speed signals originating from the second source are forwarded to the first source via WDM components 62 and 60 and high speed signals originating from the first source are forwarded to the second source via WDM components 62 and 63.

The structure of the sixth embodiment of an encoder according to the invention minimises the number of required cascade wavelength selective components by using each component four times: to separate and to combine chips from both directions.

The coder described with reference to FIG. 3a using FBG for temporal coding or frequency-hopping coding can be adapted analogously for bi-directional coding of asymmetric traffic: On the one hand, the required distribution of the gratings has to be determined, and on the other hand, means for supplying signals from different directions in parallel to the circulator have to be provided.

1. Method for coding a signal in an optical fibre network, which signal is divided into bit periods, each bit period containing one or no short light pulse, the method comprising the step of time spreading each short light pulse according to a predetermined code into a predetermined number of chips distributed over several bit periods and the step of combining the chips in a single signal.

2. Method according to claim 1, wherein the light pulses are spread in time into chips using the same frequency.

3. Method according to claim 1, wherein the light pulses are spread in time to chips using at least two different frequencies.

4. Method according to one of the preceding claims, wherein the number of the several bit periods over which the chips are spread in time are equal to or larger than the predetermined number of chips.

5. Method according to one of the preceding claims, wherein each chip is delayed in time over an integer multiple of the bit period plus a fraction of the bit period, using for each chip of one light pulse a different integer multiple and a different fraction.

6. Method according to one of the preceding claims, wherein each light pulse is spread according to a first predetermined code into chips distributed within a bit period and wherein said chips are delayed separately according to a second predetermined code over integer multiples of the bit period.

7. Method according to one of the preceding claims, wherein light pulses with a first, higher bit rate are spread in time according to a predetermined code into a predetermined number of chips distributed over several bit periods of the first, higher bit rate and wherein light pulses with a second, lower bit rate are spread in time by the same means according to a predetermined code into the predetermined number of chips distributed within one bit period of the second, lower bit rate.

8. Method according to claim 7, wherein the spreading into chips constitutes for the light pulses with the first, higher bit rate a coherent coding.

9. Optical coder for coding a signal in an optical fibre network, which signal is divided into bit periods, each bit period containing one or no short light pulse, the coder comprising means (20-25) for time spreading each short light pulse according to a predetermined code into a predetermined number of chips distributed over several bit periods and means (21′-23′) for combining the chips in a single signal.

10. Optical coder according to claim 9, wherein the means for time spreading each short light pulse comprise at least one delay line (24,25) for each chip for delaying the respective chip corresponding to the predetermined code.

11. Optical coder according to claim 10, wherein each delay line (24,25) is made up of two parts, the first part (24) providing a delay within a bit period and the second part (25) providing a delay over an integer number of bit periods.

12. Optical coder according to one of claims 10 to 11, characterised by splitters for splitting each supplied short light pulse into chips and for feeding each chip to a different one of the delay lines and by couplers for combining the chips after leaving the delay lines.

13. Optical coder according to one of claims 10 to 11, characterised by wavelength selective components (20-23,20′-23′) for splitting each supplied short broadband light pulse into several frequency bin chips and for feeding each frequency bin chip to a different one of the delay lines (24,25) and for combining the delayed frequency bin chips after being delayed by the delay lines (24,25).

14. Optical coder according to one of claims 10 to 11, characterised by wavelength selective components (21-23) for splitting each supplied short broadband light pulses into several frequency bin chips and for feeding each frequency bin chip to a different one of the delay lines (24,25) and couplers for combining the delayed chips after being delayed by the delay lines (24,25).

15. Optical coder according to claim 12, wherein the delay lines (24,25) are terminated with reflectors (30) for reflecting the chips, the delay lines (24,25) delaying the chips a second time and the chips leaving the delay lines (24,25) at their entrance points, and wherein the splitters and couplers are realised as a single means.

16. Optical coder according to claim 13, wherein the delay lines (24,25) are terminated with reflectors (30) for reflecting the chips, the delay lines (24,25) delaying the chips a second time and the chips leaving the delay lines (24,25) at their entrance points, and wherein the same wavelength selective components (20) are used for splitting short broadband light pulses and for combining delayed frequency bin chips.

17. Optical coder according to claim 9, wherein the means for time spreading each short light pulse are realised by fibre Bragg gratings (40) in an optical fibre, into which short light pulses are fed, the gratings being distributed in the optical fibre over a length corresponding to a multiple of half bit periods.

18. Optical coder according to claim 17, wherein at least some of the fibre Bragg gratings (40) have different reflection bands.

19. Optical coder according to one of claims 9 to 18, wherein for bi-directional coding of asymmetric traffic, the means (50/51,52) for time spreading short light pulses are designed for spreading short light pulses with a first, higher bit rate into a predetermined number of chips distributed over several bit periods of the higher bit rate and the same time for spreading short light pulses with a second, lower bit rate into the predetermined number of chips distributed within one bit period of the lower bit rate.

20. Optical coder according to claim 19, wherein for bi-directional coding of asymmetric traffic, the means for time spreading short light pulses comprise combined means (20) for splitting the light pulses into chips and for combining delayed chips into a single signal, said means (20) being connected for each chip to one end of a temporal delay line (50/51,52), each delay line (50/51,52) being terminated at the other end with reflecting means (30) for reflecting chips that have passed the delay line (50/51,52) back to the means (20) for splitting and combining (20).

21. Optical coder for decoding a signal encoded by an optical coder according to one of claims 9 to 20, comprising the same means as the coder used for encoding, the means for temporal spreading being suited for a time reversed delay of supplied chips.

22. Use of an optical coder according to one of claims 9 to 21 in an IP (Internet Protocol) network.

23. Use of an optical coder according to one of claims 9 to 21 in an ATM (Asynchronous Transfer Mode) network.

24. Use of an optical coder according to one of claims 9 to 21 Ethernet network.
